(19) United States
(12) Patent Application Publication
(10) Pub. No.: US 2025/0214224 A1
(43) Pub. Date: Jul. 3, 2025

(54) PORTABLE WORKBENCH

(71) Applicant: Clive Rippon, Brisbane (AU)

(72) Inventor: Clive Rippon, Brisbane (AU)

(21) Appl. No.: 18/853,481

(22) PCT Filed: Apr. 4, 2023
(86) PCT No.: PCT/AU2023/050267

§ 371 Date: Oct. 2, 2024

(30) Foreign Application Priority Data
Apr. 5, 2022 (AU) 2022900892

(51) Int. Cl. B25H 1/04; B25H 1/08

(52) U.S. Cl. CPC B25H 1/04; B25H 1/08

(57) ABSTRACT

A portable workbench (10) having a workbench surface and a receptacle retainer configured to receive an upper edge of a receptacle (30) and a demountable wall. The receptacle may be, for example, a rubbish, trash, or garbage bin. In a preferred form (as illustrated) the bin is a wheelie bin. When located on the receptacle, the workbench surface has an aperture located above the receptacle which can be used to easily dispose of waste during use. The portable workbench (10) may be removed from the receptacle and stored or easily transported for use at another site.

### FIELD OF THE INVENTION

The invention relates to a portable workbench. In particular, the invention relates, but is not limited, to a portable workbench that is configured to be placed on top of a receptacle, such as a rubbish bin, for support use and folded substantially flat for transportation and storage.

### BACKGROUND TO THE INVENTION

Reference to background art herein is not to be construed as an admission that such art constitutes common general knowledge.

Many people have a home workshop, or the like, for do-it-yourself (DIY) and/or handyman type operations. In some cases this may be a large workshop with considerable supplies and hardware and in other cases it may be small. In all cases a workbench is typically a key element of the workshop. In many cases, however, there is limited space and/or nowhere for such a workshop to be located. For example, those living in apartment buildings.

For people working on a site, such as tradesmen, a workbench is often unavailable. They typically carry saw horses and/or have a collapsible workbench that can be set up at the site. These are bulky and quite large, particularly due to their legs which are typically long and rigid.

A further issue with workbenches is that during work a lot of waste and spoils is often created. For example, off cuts, dust, shavings, etc. Often these collect on the workbench and/or fall to the floor. Large off cuts can be picked up by hand for disposal but doing so exposes the user to injury through sharp edges or splinters, or the like. A broom or dustpan and brush are often used to clean up smaller sized waste. However, this not only takes time and effort, but also often still leaves behind dust and fines.

### OBJECT OF THE INVENTION

It is an aim of this invention to provide a portable workbench which overcomes or ameliorates one or more of the disadvantages or problems described above, or which at least provides a useful alternative.

Other preferred objects of the present invention will become apparent from the following description.

### SUMMARY OF INVENTION

In one form, although it need not be the only or indeed the broadest form, there is provided a portable workbench comprising: a workbench surface having an aperture therein; at least one receptacle retainer configured to receive an upper edge of a receptacle; wherein, in use, the aperture is located above a cavity of the receptacle.

At least one guide may be located on the workbench surface. The at least one guide may comprise two aligned members protruding from the workbench surface. An end of the guide may be angled between 0° and 45°. In a form it may be angled at 45°. The guide may further comprise a movable barrier to selectively allow access to the angled end of the guide.

The portable workbench may further comprise a demountable wall. The demountable wall may be configured to support a lid of the receptacle. The demountable wall may flank the aperture along a back edge of the workbench surface. The demountable wall may be in the form of foldable wall hinged to the workbench surface. The foldable wall may be configured to move between a closed position and an open position. The closed position may be when the foldable wall is in a plane that is substantially parallel to the workbench surface. The open position may be when the foldable wall is located in a plane transverse to the workbench surface. A locking member may be provided that selectively prevents the foldable wall from moving from the open position to the closed position.

The portable workbench may further comprise one or more protrusions configured to engage with an upper edge of the receptacle. The one or more protrusions may be located on an opposite side of the portable workbench to the workbench surface.

The receptacle retainer may comprise one or more grooves configured to receive the upper edge of the receptacle. The one or more grooves may comprise a groove or portion of a groove that is transverse to another groove or portion of a groove.

The workbench surface may have a plurality of holes configured to retain tools. The workbench surface may have a plurality of sized holes for diameter measurement. The workbench surface may have one or more indicators. The one or more indicators may comprise a ruler. The one or more indicators may comprise angled lines at specific angles such as, for example, 45°.

The portable workbench may further comprise one or more struts configured to engage with a lid of the receptacle. The one or more struts may comprise elongate members which, in use, extending between the workbench surface and a free end of the lid of the receptacle. The struts may be mounted in or to the workbench surface. The struts may support a drill press tool.

The portable workbench of any one of claims 1 to 16, wherein the aperture is at least primarily defined by substantially parallel inner side walls and a substantially perpendicular inner end wall.

The aperture may be further defined by an angled edge. The angled edge may be located between the inner end edge and one of the inner side edges.

The receptacle is preferably a rubbish bin. Preferably the rubbish bin has an upper edge of predetermined size. The rubbish bin may be wheeled. Preferably the receptacle is a standard sized wheelie bin. In use, the aperture preferably aligns with a cavity of the rubbish bin.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a top plan view of a portable workbench surface;

FIG. 2 illustrates a side view showing the underside of a portable workbench in a collapsed position;

FIG. 3 illustrates a perspective view of the portable workbench of FIG. 2 when located on top of a receptacle in the form of a type of rubbish bin;

FIG. 4 illustrates a close-up perspective view of a portion of the portable workbench illustrated in FIGS. 2 and 3;

FIG. 5 illustrates a perspective view of the portable workbench of FIGS. 2 to 4 when set up;

FIG. 6 illustrates a side view of the portable workbench as set up in FIG. 5;

FIG. 7 illustrates a close-up view of a portion of the workbench surface having a magnet;

FIG. 8 illustrates a close-up perspective view of a portion of the workbench read for use; and

FIG. 9 illustrates a close-up perspective view of a portion of the workbench in use.

### DETAILED DESCRIPTION OF THE DRAWINGS

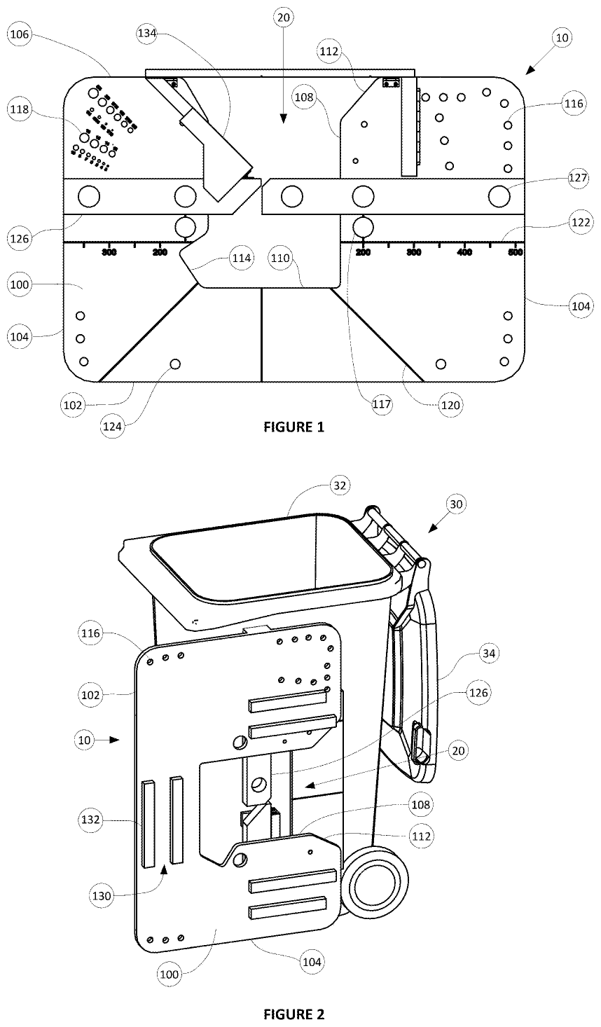

FIG. 1 illustrates a workbench surface 100 of a portable workbench 10 in one form. The workbench surface 100 is a generally rigid planar member with rounded corners. The workbench surface 100 is generally rectangular with an aperture 20 therein. As a result of the aperture 20, the workbench surface 100 in the illustrated form is generally ‘U’ shaped. The workbench surface 100 has a longitudinally aligned front edge 102, two substantially parallel side walls 104, and a back edge 106 which has a cut-out for the aperture 20. It should be appreciated that the aperture 20 could be enclosed (e.g. a hole) with a single long back edge 106.

The aperture 20 is formed by substantially parallel inner side edges 108 and a substantially perpendicular inner end edge 110. A chamfer 112 is provided between the back edge 106 and the substantially parallel inner side edges 108. Between the inner end edge 110 and one of the inner side edges 108 is an angled edge 114. The angled edge 114 extends approximately 45° to its adjacent inner side edge 108. In the illustrated form the angled edge 114 is recessed such that there are two angled edges substantially perpendicular to each other (and both at approximately 45° to the inner side edges 108 and inner end edge 110) that further expand the aperture 20.

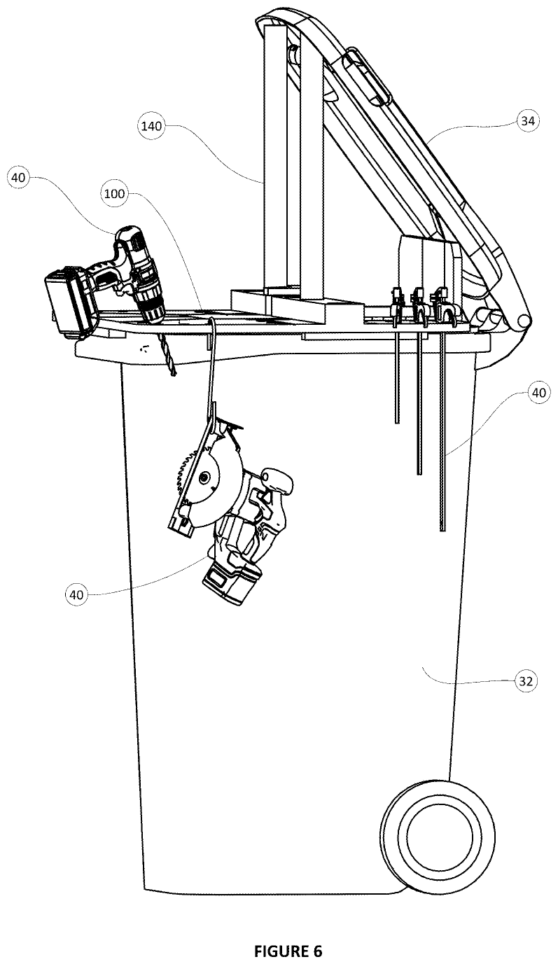

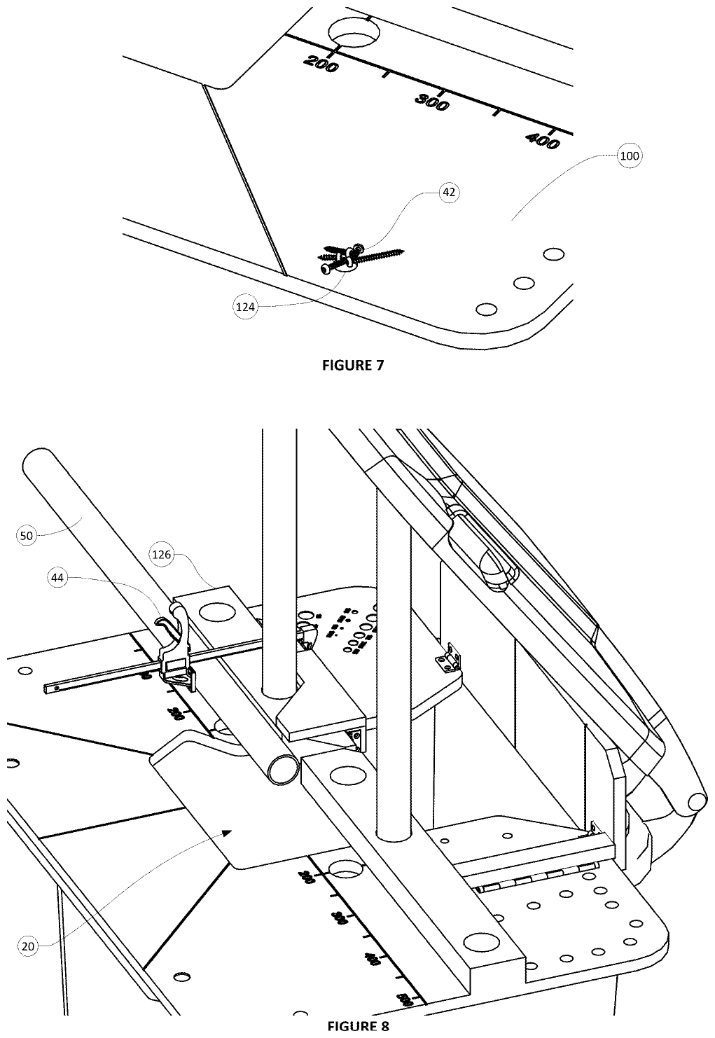

Various holes 116 are provided for tools or accessories, such as screw drivers, clamps, pencils, pens, power tools, and/or hooks (e.g. see FIGS. 5 and 6). One or more drill holes 117 can also be provided. The drill holes 117 are preferably located adjacent the aperture 20 for reasons that will become apparent. In use, the drill holes 117 are larger than the accessory/tool holes 116 and may be used to support an article being drilled in a manner that allows a drill bit of a drill to pass through the article and into the drill hole 117 without damaging the workbench surface 100. Sized holes 118 can also be provided to allow quick identification and sizing of drill bits or bolts, or the like. One or more indication lines 120 can be provided. Some may be provided with measurements such as ruler 122. The indication lines 120 and/or ruler 122 are preferably etched into the surface, but may be painted, engraved, adhered, or the like. One or more magnets 124 may be located either in the surface 100, or if sufficiently powerful enough within or underneath the surface 100, to allow retention of metal components (e.g. see FIG. 7). Illustrated in dashed lines is a proposed location of a guide 126 (not shown in FIG. 1).

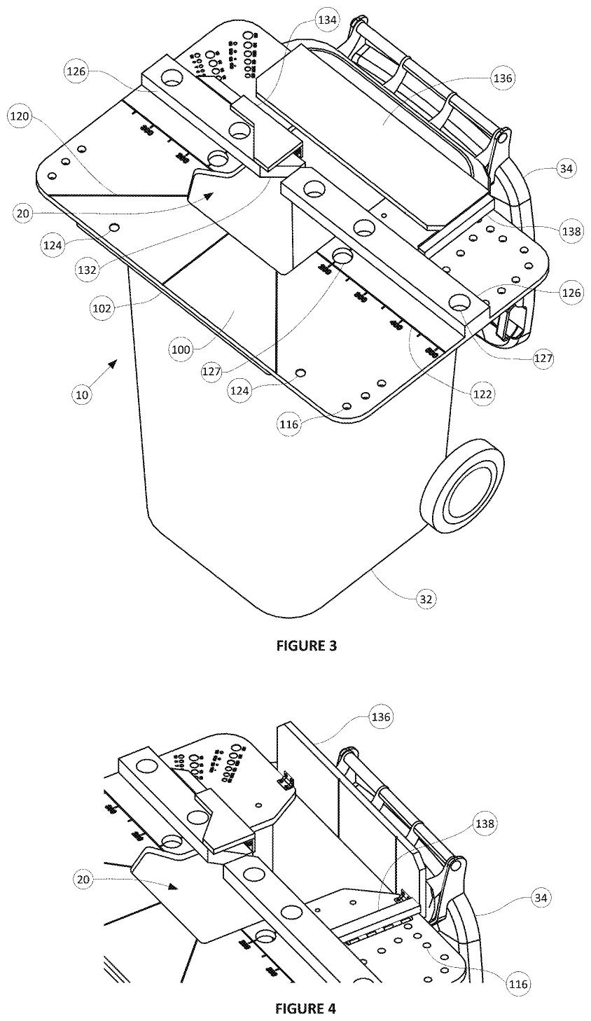

FIG. 2 illustrates the underside of a form of the portable workbench 10 leaning against a receptacle in the form of a wheeled rubbish bin 30 (more clearly seen in FIGS. 5 and 6). This form of rubbish bin 30 has a body 32 and hinged lid 34 and is often known in Australia, New Zealand, and the UK as a ‘wheelie bin’. In other countries rubbish bins may be known as garbage cans, trashcans, dustbins, or the like, and no limitation is meant thereby.

Located on the underside of the workbench surface 100 are receptacle retainers. In the illustrated form, the receptacle retainers comprise grooves 130 located and sized to receive an upper edge of the receptacle 30. There is at least one groove 130 arranged transversely to another groove 130 to provide both retention in more than one axis. The grooves 130 in the illustrated form are defined by pairs of spaced apart protrusions 132. It should be appreciated, however, that a single groove 130, that corresponds to the upper edge of the receptacle 30, could be recessed into the workbench surface 100. It should also be appreciated that protrusions 132 could be in the form of pegs or rails.

FIG. 3 illustrates the portable workbench 10 when located on top of the rubbish bin 30. The aperture 20 aligns with the cavity of the rubbish bin 30 such that waste material can drop straight therein. The portable workbench 10 is securely held in place on top of the rubbish bin 30 through a combination of weight and retainers located underneath. As can be seen in FIG. 3, the guide 126 may comprise two aligned members. One of the members has a 45° angled end 132 to assist with a mitre cut. A movable barrier 134 is provided to selectively allow access to the angled end 132 of the guide 126. The guide may comprise a single member or more than two members. The guide 126 may also have one or more clamp holes 127 to assist with clamping articles thereto. Also seen in FIG. 3 is a demountable wall in the form of a foldable wall 136 in a storage and/or transport position that is parallel to the workbench surface 100.

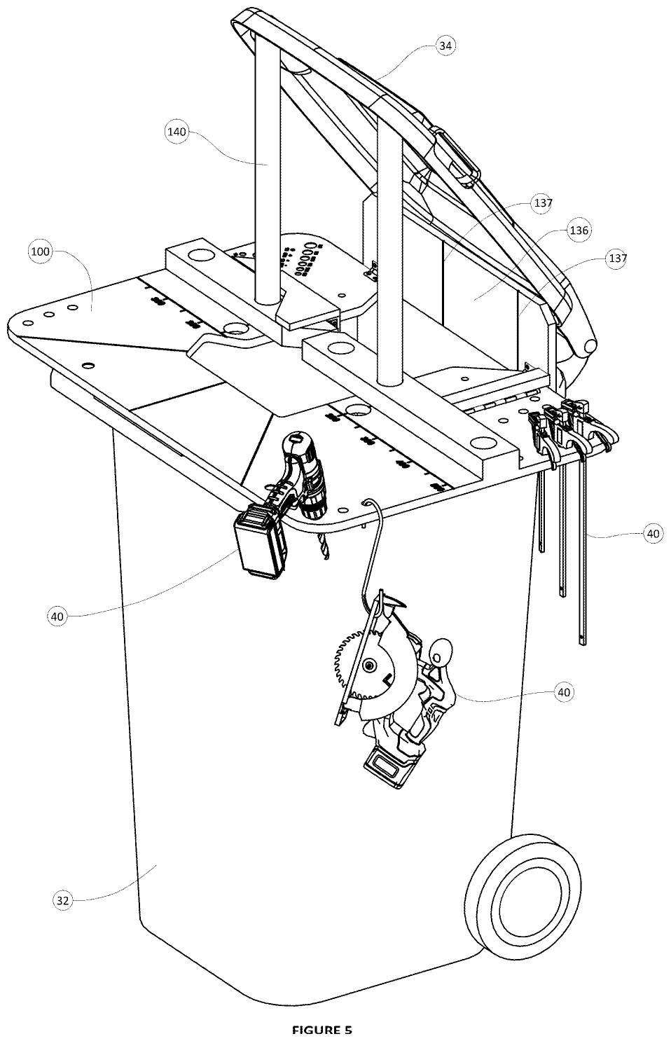

FIG. 4 illustrates a close up of a rear portion of the portable workbench 10, adjacent the aperture 20, with the foldable wall 136 in its upright position. The foldable wall 136 flanks the aperture 20 along the back edge 106 and provides a splashback or sorts. Furthermore, the foldable wall 136 can be used to support the lid 34 of the rubbish bin 30 over the work area (as illustrated in FIGS. 5 and 6). A locking member 138, in the form of a hinged rib, is provided to prevent the foldable wall 136 from closing inadvertently. The locking member 138 can be seen in an open position in FIG. 3 and in a locked position in FIG. 4. Also visible on the foldable wall 136 are alignment indicators 137 which can be used with laser sighting tools. In the illustrated form, the first indication (on the left) is for a 0° alignment and the second indication (on the right) is for a 45° alignment. It should be appreciated that more or less alignment indicators 137 could be provided as desired.

FIGS. 5 and 6 illustrate the portable workbench 10 in a fully set up configuration on top of the rubbish bin 30. Various tools 40 are shown located on, in, or hanging (via hooks) from the workbench 10. The lid 34 of the rubbish bin 30 is supported by the foldable wall 136. Optional struts 140 are also illustrated. They may be used support a free end of the lid 34. They can also be used for a drill press tool (not shown). The struts can assist with support and aligning the drill press. The struts 140 are removably mounted to or in the workbench surface 100. In the illustrated form, the struts 140 are configured to be retained by the clamping holes 127.

FIG. 7 illustrates a close up of the magnet 124, located in the workbench surface 100, retaining screws 42. The magnet 124 is preferably recessed to provide an uninterrupted workbench surface 100. A magnet with sufficient strength could be located inside or on the underside of the workbench surface 100.

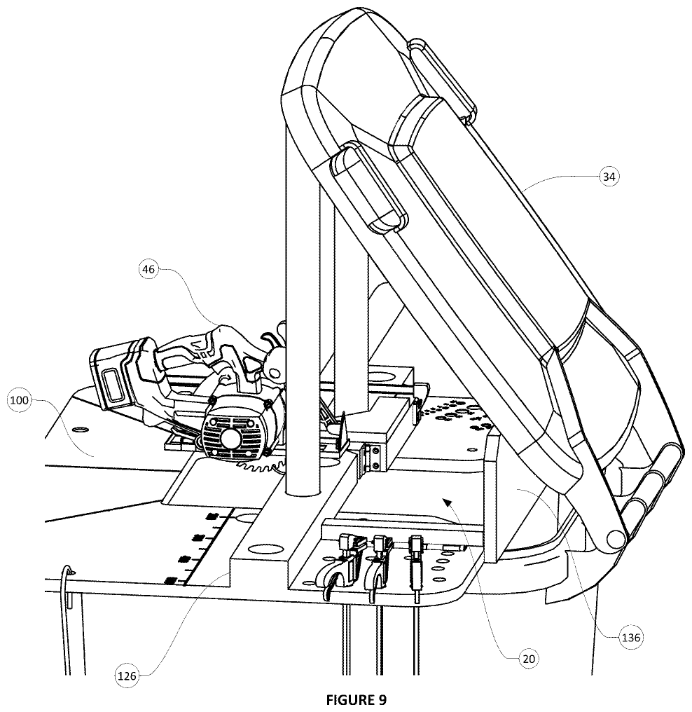

FIG. 8 illustrates the portable workbench 10 in use. A piece of pipe 50 has been clamped with clamp 44 to the guide 126. An end of the pipe 50 is located over the aperture 20. FIG. 9 illustrates a power saw 46 being used to cut the pipe 50. As the cut is complete the free end of the pipe 50 falls straight into the rubbish bin 30.

Advantageously the portable workbench 10 can be stored substantially flat with a small footprint until needed. When needed, it can be quickly placed and set up on top of an appropriate receptacle, such as a rubbish bin, for use. The rubbish bin 30 provides a strong and sturdy support for the portable workbench 10. During use, waste can drop directly into the receptacle. Any waste that may accumulate on the workbench surface 100 can be easily swept into the receptacle via the aperture 20. The demountable wall 136 not only supports the lid 34 of the bin 30, but also provides a splashback to catch debris and guide it into the aperture 20. The workbench surface 100 can conveniently hold numerous tools and provides different guides and measurements to perform different types of jobs.

When complete, the portable workbench 10 can be easily collapsed and removed from the rubbish bin 30 and stored in a flat configuration, this making the portable workbench 10 particularly convenient for users with limited space (e.g. those living in an apartment) and/or those needing to travel to different sites.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

As used herein, an element or operation recited in the singular and proceeded with the word “a” or “an” should be understood as not excluding plural elements or operations, unless such exclusion is explicitly recited. Furthermore, references to “one embodiment” of the present disclosure are not intended to be interpreted as excluding the existence of additional embodiments that also incorporate the recited features.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A portable workbench comprising:
a workbench surface having an aperture therein;
at least one receptacle retainer configured to receive an upper edge of a receptacle; and
a demountable wall;
wherein, in use, the aperture is located above a cavity of the receptacle.

2. The portable workbench of claim 1, further comprising at least one guide located on the workbench surface.

3. The portable workbench of claim 2, wherein the at least one guide comprises two aligned members protruding from the workbench surface.

4. The portable workbench of claim 2, wherein an end of the guide is angled between 0° and 45°.

5. The portable workbench of claim any one of claims 2, wherein the guide further comprises a movable barrier to selectively allow access to the angled end of the guide.

6. The portable workbench of claim 1, wherein the demountable wall can be configured to extend transversely to the workbench surface.

7. The portable workbench of 1, wherein the demountable wall is configured to support a lid of the receptacle.

8. The portable workbench of claim 1, wherein the demountable wall flanks the aperture along a back edge of the workbench surface.

9. The portable workbench of claim 1, wherein the demountable wall is in the form of foldable wall hinged to the workbench surface.

10. The portable workbench of claim 9, wherein the foldable wall is configured to move between a closed position, in which it is in a plane that is substantially parallel to the workbench surface, and an open position, in which it is located in a plane transverse to the workbench surface.

11. The portable workbench of claim 9, further comprising a locking member that selectively prevents the foldable wall from moving from the open position to the closed position.

12. The portable workbench of claim 1, further comprising one or more protrusions configured to engage with an upper edge of the receptacle, the one or more protrusions being located on an opposite side of the portable workbench to the workbench surface.

13. The portable workbench of claim 1, wherein the receptacle retainer comprises one or more grooves configured to receive the upper edge of the receptacle.

14. The portable workbench of claim 12, wherein the one or more grooves comprise a groove or portion of a groove that is transverse to another groove or portion of a groove.

15. The portable workbench of claim 1, wherein the workbench surface has a plurality of holes configured to retain tools.

16. The portable workbench of claim 1, further comprising one or more struts configured to engage with a lid of the receptacle.

17. The portable workbench of claim 1, wherein the aperture is at least primarily defined by substantially parallel inner side walls and a substantially perpendicular inner end wall.

18. The portable workbench of claim 17, wherein the aperture is further defined by an angled edge located between the inner end edge and one of the inner side edges.

19. The portable workbench of claim 1, wherein the receptacle is a rubbish bin.

20. The portable workbench of claim 1, wherein the receptacle is a wheelie bin.
